(19) United States
(12) Patent Application Publication
(10) Pub. No.: US 2009/0015065 A1
(43) Pub. Date: Jan. 15, 2009

(54) Centralized powering system and method

(76) Inventors: Michael Anthony Becigneul, Timberlea (CA); Shawn Flynn, Timberlea (CA); R. Glen Rockett, Timberlea Village (CA)

Correspondence Address: G. ronald Bell & Associates, P.O. Box 2450, Postal Station D, Ottawa,ON K1P 5W6, CA

(21) Appl. No.: 11/658,410

(22) PCT Filed: Jul. 29, 2005
(86) PCT No.: PCT/CA2005/001185

§ 371 Date: Jan. 25, 2007

(30) Foreign Application Priority Data
Jul. 30, 2004 (CA) 2476331

(51) Int. Cl. H02J 3/14

(52) U.S. Cl. 307/31

(57) ABSTRACT

A system and method is disclosed for delivering controlled electrical power, and more specifically, a system and method for providing a continuous, reliable and inexpensive supply of utility and emergency power to a cable network for use by a plurality of active components in the network. The system comprises a first voltage regulating means (100) having an input side connected to the power source and an output voltage side connected to a second voltage regulating (27) means disposed proximate to said active components in said network. The first voltage means (100) is capable of regulating a source voltage to an intermediate voltage. The second voltage regulating means (27) has an input side for receiving power at the intermediate voltage from the first voltage regulating means (100) and an output side connected to the active components in the network. The output side of the second voltage regulating means (27) supplies the predetermined voltage for operation of the active components in the network. At least one dedicated cable (23) for connecting the first voltage regulating means (100) to the second voltage regulating means (27) is provided.

### FIELD OF THE INVENTION

The present invention relates to a system and method for delivering controlled electrical power, and more specifically to a system and method for providing a continuous, reliable and inexpensive supply of utility and emergency power to a cable network for use by a plurality of active components in the network.

### BACKGROUND OF THE INVENTION

Business opportunities in traditional cable television (CATV) markets are growing to meet the increasing needs of subscribers. As a result, the interaction of constant power amplifiers and network interfaced unit-powered devices are increasing the dynamic power demands on network power supplies. Network powered loads or active components such as fibre optic nodes, amplifiers, telephone voice ports and other new devices create power demands at different times and locations along the network. Access to emergency power during power shortages is another important requirement. Reliable electrical power is thus essential to the ongoing growth of the CATV market.

Traditional cable network architecture must be adapted to ensure reliable service both now and in the future. By way of background, cable power is typically distributed on either distributed powering or centralized powering network. Both systems use alternating current (AC) network power supplies to optimize the power factor when providing square wave output voltage waveforms for the active front end amplifier loads. The AC network power supply of choice is typically the standard ferroresonant regulating transformer since it provides both voltage regulation and high isolation of the cable plant from the utility grid. Switchmode network power supplies may also be used.

Each network powering system has its own respective advantages. In the distributed power system, illustrated in FIG. 1, single transformer network power supplies are mounted along the cable run at the pole or on the ground. Power is decreased to 110/220 volts of alternating current (VAC) at the public utility transformer and sent to the network power supply 10 located near the active components in the network. It passes through a disconnect switch 11 and into the network power supply 10 to further decrease the voltage to the 30, 63, 75 or 87 VAC specification required by the active components in the network. Next, it is routed by coaxial cable wire 12 into a nearby power inserter 13 where it is provided to the active components in the network. A bank of battery cells 14 at the network power supply provides emergency power on a temporary basis when the power is interrupted. FIG. 1 illustrates the configuration of equipment at a typical distributed powering system location. FIG. 2 illustrates the distribution of several network power supplies within a wider conventional distributed powering network system.

Although the power is not necessarily related to the radio frequency (RF) signal and flow, the layout of power segments is nonetheless constrained by some limiting considerations. The layout design must compensate for the voltage drop resulting from the natural impedance of the coaxial cable. The distributed powering system minimizes impedance losses by locating the network power supply and power inserter together, thereby minimizing the length of coaxial cable required to connect these units to the network.

However, this design configuration includes disadvantages. In a prolonged power failure where the temporary battery cells are depleted, the absence of a locally installed emergency power source (e.g. generator) creates a need for portable power source and fuel at each network power supply. Additional disadvantages include the requirement to match one utility power connection to each network power supply.

The centralized powering system is the other standard network architecture configuration. In this system, the network power supplies are installed away from the local poles at a central location 15 with the back-up generators and fuel. FIG. 2a illustrates the distribution of several network power supplies within the central powering system network.

The configuration of equipment at a typical centralized powering system location is illustrated in FIG. 3. Power from the public utility enters the central location 15 and is distributed through an automatic transfer switch (ATS) 16 to the breaker panel 17 and to several centralized network power supplies 18 where the voltage is decreased to the appropriate 30, 63, 75 or 87 VAC specification. The power is then distributed by coaxial cable 19 to the power inserter 20 at the local pole where it is provided to the active components in the network. The network power supplies 18 at the central location 15 are provided with a battery bank which takes over the power load on a temporary basis in the event of a power outage. The emergency power source 21 at the central location 15 then provides emergency power through the automatic transfer switch (ATS) 16 and into the breaker panel 17 and network power supply 18 in the usual manner.

The configuration of the centralized powering system improves the reliability of continuous power supply in the event of a power outage. The installation of the battery bank, generators and fuel at one central site facilitates easy access and reduces security risk.

One disadvantage of this system is the additional expense incurred to purchase the land that must house the equipment. In addition, the voltage drop losses become significant because an increased length of coaxial cable 19 is required in order to connect the central location 15 to the power inserters 20 at each pole. As a result, the central locations 15 must be installed relatively close to the local poles to limit the attenuation. Several central locations 15 must be strategically dispersed within the region where the active components in the network are located. The possibility of power interruption due to severed wires also increases with the length of coaxial cable required.

Another disadvantage is the weight and number of coaxial cables required in the traditional centralized power system. In general, one coaxial cable is run to each local satellite network power supply. In the situation where a significant number of network power supplies must be provided with power, a corresponding number of coaxial cables are required. This creates installation difficulties and future concerns related to maintenance and repairs due to environmental factors such as ice loading.

A further disadvantage is the inability of the traditional centralized powering solution to function with cable networks configured to operate at 87 VAC. Although the maximum output voltage of a network power supply is 87 VAC, this voltage will decrease before it enters the cable network due to the inherent voltage drop in the coaxial cable. As a result, the output voltage received at the cable network is insufficient for proper operation of active components in the network because they are configured to operate at 87 VAC.

U.S. Pat. No. 5,677,974 to Elms et al. discloses a network and method of distributing power and optical signals that includes installing a hybrid communications and power cable between a source location and another relatively remote location. The network for distributing power and optical signals to the remote location includes a centrally located alternating current power supply; a hybrid cable for providing optical signals and for transmitting power from the centrally located power supply to the remote location; a terminal located at the remote location for isolating the power from the optical signals; and a power supply in communication with the terminal, for receiving the power transmitted by the hybrid cable for use in powering active components in the network.

However, there are several practical limitations that preclude the widespread implementation of the network as disclosed by Elms et al. In particular, size and weight considerations of the hybrid cable limits the length thereof to a maximum based on manufacturing, packaging, and transportation logistics. This in turn necessitates the use of multiple splice devices and splitter taps or junction boxes for connecting different segments of the hybrid cable. The cost of the splicing devices is much higher compared to the optical fibers that transmit the optical signal and the splitter taps act as a source for introduction of noise into the network.

From the previous discussion it can be observed that the goals of continuous access to cable network power distribution with minimal voltage losses can be achieved with a capital intensive commitment of land and equipment at numerous local sites. While these commitments can be reduced to some degree through centralization of equipment, the advantages gained are offset by the inherent power attenuation created by additional coaxial cable requirements. Although an alternative centralized power and signal distribution method is taught by Elms et al., the method therein entails the use of highly sophisticated and expensive hybrid communications and power cables. Accordingly, there remains a clear need to provide reliable continuous power to the active components in a network without i) incurring either exorbitant hardware and land costs or, ii) excessive cable costs and associated voltage problems.

### SUMMARY OF THE INVENTION

It is an object of the present invention to provide a continuous, reliable and inexpensive means of supplying electrical power to the end point of use without creating an excessive impedance loss in the distribution. Another object is to provide a means of supplying power to the active components in a cable network that makes efficient use of the land and physical plant. A further object of the present invention is to provide a means of supplying power to the active components in a cable network that makes efficient use of new and/or existing transmission, distribution, and emergency power equipment.

According to one aspect of the invention, there is provided a system for providing power from a utility power source to remote active components in a cable network, the active components requiring a predetermined voltage for their operation. The system comprises a first voltage regulating means having an input side connected to the power source and an output voltage side connected to a second voltage regulating means disposed proximate to said active components in said network. The first voltage means is capable of regulating a source voltage to an intermediate voltage. The second voltage regulating means has an input side for receiving power at the intermediate voltage from the first voltage regulating means and an output side connected to the active components in the network. The output side of the second voltage regulating means supplies the predetermined voltage for operation of the active components in the network. At least one dedicated cable for connecting the first voltage regulating means to the second voltage regulating means is provided.

The first voltage regulating means is typically housed in a centralized location relative to a number of active components in a network. The first voltage regulating means will also commonly comprise an incoming alternating current power supply, an alternating current power generator, an automatic transfer switch, at least one uninterrupted power supply means, a transformer, and a power distribution panel configured for regulating the source voltage to an intermediate voltage.

The output of the first voltage regulating means is preferably a regulated three-phase alternating current power supply. The output voltage may be advantageously maintained within local regulations, for example, at 300 VAC in Canada.

In a preferred embodiment of the invention, the dedicated cable for transmission of electrical power is a damage-resistant cable, e.g. a protected cable.

In an especially preferred embodiment, the dedicated cable for transmission of electrical power is adapted for the distribution of regulated three-phase 300 VAC power supply. For instance, the dedicated cable may be an armored cable comprising 4-conductor aluminum, #2 gauge wires with a rubberized outer jacket.

The second voltage regulating means generally comprises at least one rectifier, at least one inverter, and means for actively correcting the incoming power supply.

An output side of the second voltage regulating means may advantageously provide a single phase 110 VAC power supply, a single phase 220 VAC power supply, or both. Alternatively, the output side may provide one or a combination of the following: 30, 63, 75, and 87 volts quasi square wave power supply. In yet another alternative, the output side of may provide a combination of single phase alternating current power supply and quasi square wave power supply.

The location of the second voltage regulating means may be configured such that the intermediate voltage from the first voltage regulating means received at the input side of the second voltage regulating means is above a threshold voltage, for instance, the threshold voltage may be 170 VAC.

According to another aspect of the invention, there is provided a method for providing power from a utility power source to one or more remote active components in a cable network. The active components require a predetermined voltage for their operation. The method comprising the steps of: regulating a source voltage to produce an intermediate-voltage power; distributing said intermediate-voltage power to said remote active components in said network; and, actively correcting said intermediate-voltage power at a location proximate to said active components to a predetermined voltage for the operation of said active components in said network.

In the aforementioned method, the intermediate voltage power is advantageously sent through a dedicated single and/or a multi-conductor damage resistant line.

Other objects and advantages of the present invention will become apparent from a careful reading of the detailed description provided herein, with appropriate reference to the accompanying drawings.

### BRIEF DESCRIPTION OF THE DRAWINGS

Preferred embodiments of the present invention will now be described with reference to the accompanying drawings, wherein;

FIG. 1 is a schematic diagram showing the configuration of equipment at a typical conventional distributed powering system location.

FIG. 2 is a schematic diagram showing the distribution of several power supplies within the wider distributed powering network system.

FIG. 2a is a schematic diagram showing the distribution of several network power supplies within the central powering system network.

FIG. 3 is a schematic diagram showing the configuration of equipment at a typical centralized powering system location.

FIG. 4 is a schematic diagram showing the configuration of equipment at a new centralized powering system location according to an embodiment of the present invention.

FIG. 5 is a schematic diagram showing the configuration of equipment at a new centralized powering system location according to another embodiment of the present invention.

### DETAILED DESCRIPTION OF THE INVENTION

The present invention relates to a centralized powering method which utilizes power distribution and transmission equipment configured to provide a continuous and reliable power to a cable network.

Implementation of the system and method as described in the following discussion will enable the active components in a cable network to receive uninterrupted power with minimal voltage losses incurred. The equipment and land required to implement this configuration are also significantly less than the comparable requirements in the traditional centralized powering system.

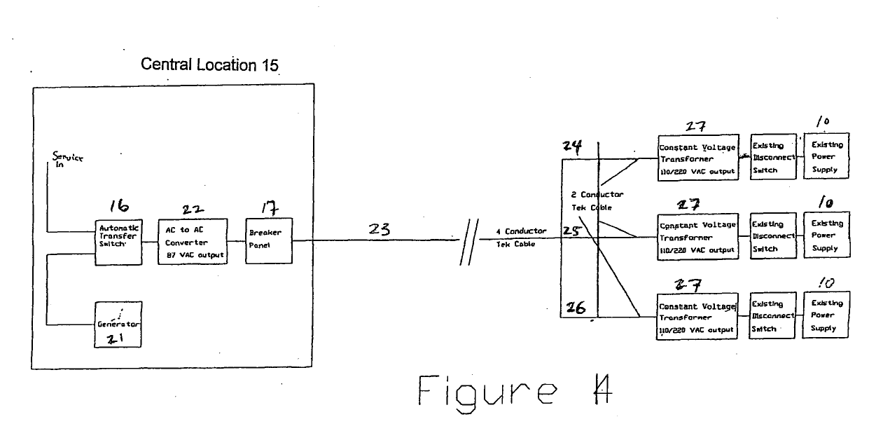

A preferred embodiment is illustrated in FIG. 4. The centralized powering method utilizes a equipment configuration at the central location 15 so as to provide a continuous and reliable power to a cable network. The first voltage regulating means 100 comprises a transformer 22 such as an AC to AC converter which is installed immediately after the automatic transfer switch 16 and prior to the breaker panel or a power distribution panel 17.

Power at a voltage of V1 VAC from a utility power source flows through the automatic transfer switch 16 and into the transformer 22. The output of the transformer 22 is typically a regulated three-phase alternating current power supply at an intermediate voltage of V2 VAC. The regulated three-phase alternating current power supply is then distributed to a cable network via the breaker panel 17 by means of a dedicated cable 23 in order to power remote active components (not shown here) in a cable network. At the remote location, an input side of the second voltage regulating means 27 receives a regulated three-phase alternating current power supply at a voltage of V4 VAC. An output side of the second voltage regulating means 27 provides a predetermined voltage sufficient for the operation of the active components in the network. The voltage V4 VAC received at the input side of the second voltage regulating means 27 may be different from the intermediate voltage V2 VAC at the output side of the first voltage regulating means 100 due to several factors such as, transmission loss, network load, etc. The location of the second voltage regulating means 27 may be strategically positioned such that the intermediate voltage V4 from the first voltage regulating means 100 received at the input side of the second voltage regulating means 27 is above a threshold voltage.

In the event of a power outage, the automatic transfer switch 16 automatically supplies power to the transformer 22 from the back-up generator 21 until normalcy is restored. The back-up generator 21 may supply power at a voltage of V3 VAC. However, the transformer 22 will force the outputto a regulated three-phase alternating current power supply at an intermediate voltage of V2 VAC prior to distribution.

For instance, 110/220 VAC power from a utility power source flows through the automatic transfer switch 16 in a typical manner, then enters the transformer 22 where it is regulated to 87 VAC. The regulated power is then distributed through the breaker panel 17 into a dedicated cable 23 such as a protected cable, and routed away from the central location 15 to the remote network power supplies 10 at the poles. The current drawn through the cable is limited by ensuring that the input voltage at the remote location always exceeds a threshold voltage, for example, 50 VAC.

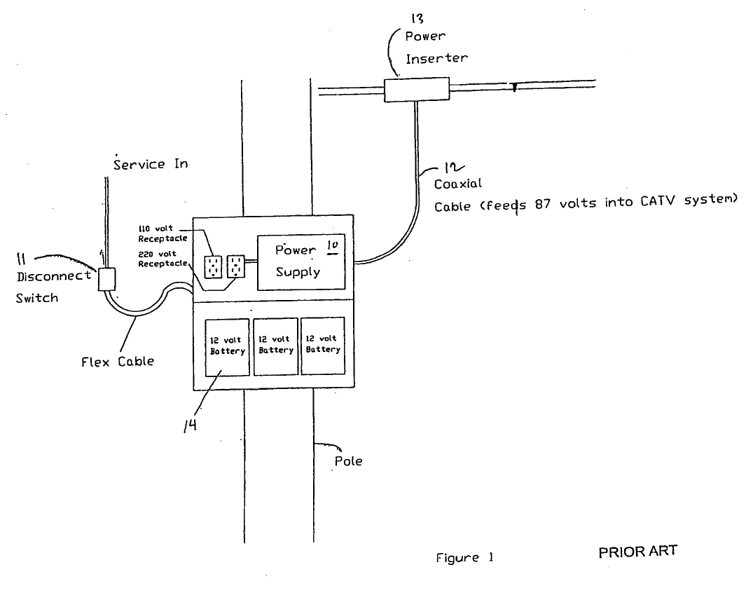

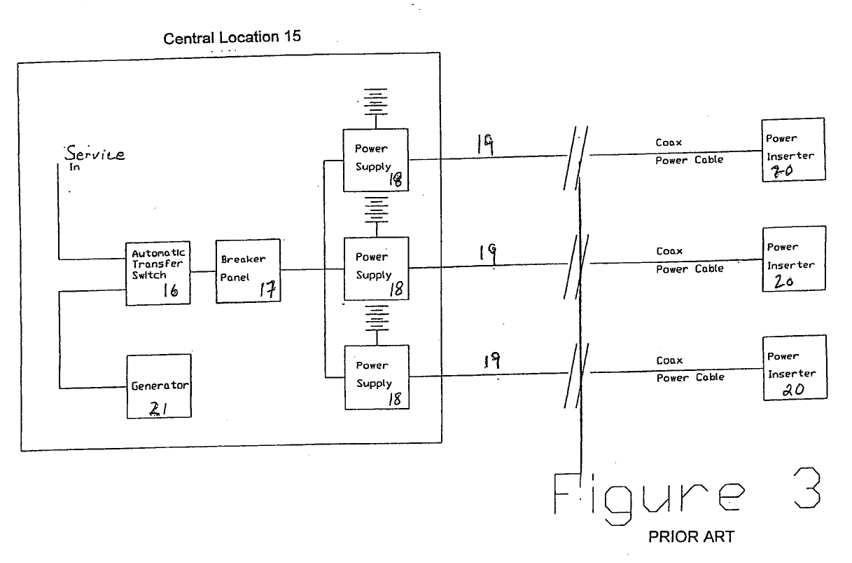

In this example, the protected cable 23 comprises three conductor wires and one common neutral wire, enabling the power to be further distributed into three smaller cables 24, 25, and 26 which service individual remote power supplies 10. At the poles, the regulated 87 VAC power is actively corrected and is increased to 110/220 VAC by the second voltage regulating means 27. The increased voltage is then routed in the usual manner through the disconnect switch 11 and into the network power supply 10 and power inserter 13, 20 as described in FIGS. 1 and 3.

In another embodiment of the centralized powering method, the first voltage regulating means 100 further comprises one or more uninterrupted power supplies (UPS) 28 disposed between the automatic transfer switch 16 and the transformer 22. In the event of a power outage, the UPS 28 provides the power supply to the transformer 22 until such time as the output of the back-up generator 21 has stabilized.

In a further embodiment, the output V2 of the first voltage regulating means 100 may be advantageously maintained within local regulations, for example, at 300 VAC in Canada. The second voltage regulating means 27 may be positioned such that the intermediate voltage V4 from the first voltage regulating means 100 received at the input side of the second voltage regulating means 27 is above a threshold voltage, for instance, the threshold voltage may be 170 VAC. Additionally, the second voltage regulating means 27 generally comprises at least one rectifier, at least one inverter, and means for actively correcting the incoming power supply. The components of the second voltage regulating means 27 are commercially available and may be configured using common methods known in the art.

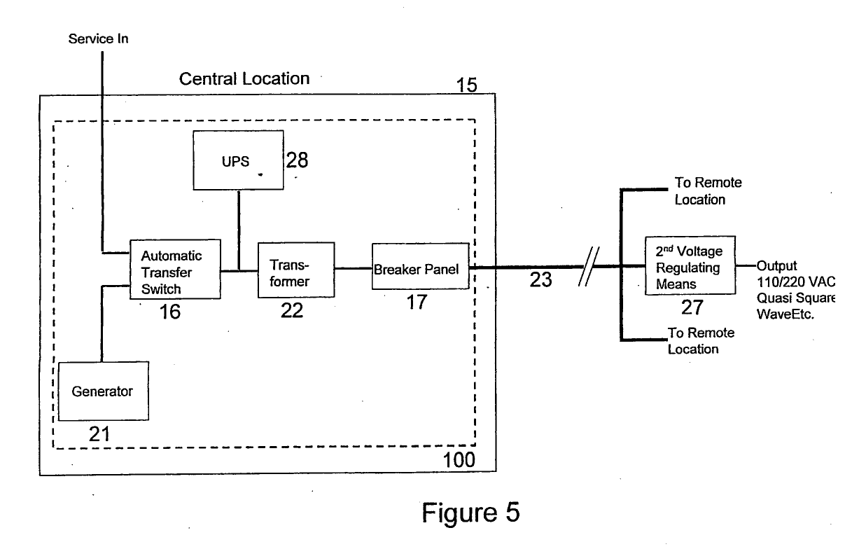

As illustrated in FIG. 5, the output side of the second voltage regulating means 27 may advantageously provide a single phase 110 VAC power supply, a single phase 220 VAC power supply, or both. Alternatively, the output side may provide one or a combination of the following: 30, 63, 75, and 87 volts quasi square wave power supply. In yet another embodiment, the output side may provide a combination of single phase alternating current power supply and quasi square wave power supply.

The preferred configurations as shown in FIGS. 4 and 5 illustrate the introduction of several significant modifications and improvements to the typical centralized powering system previously described in FIG. 3.

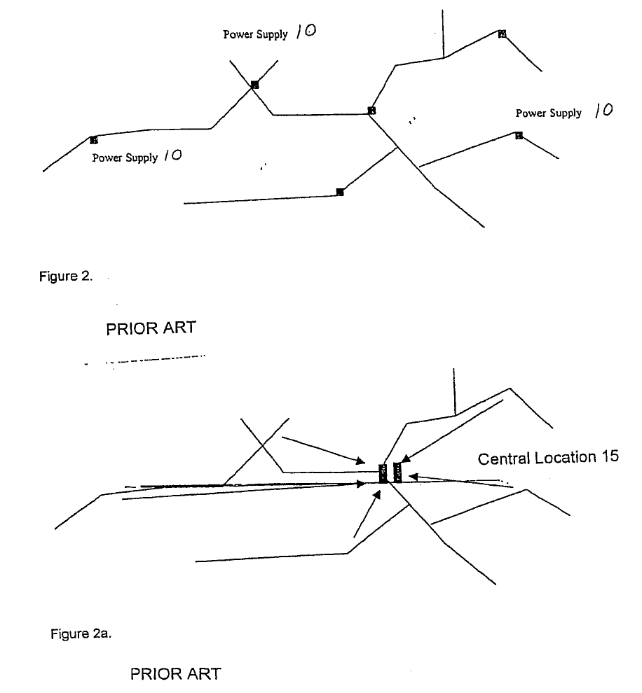

Implementation of the present invention allows the amount of equipment installed at the central location 15 to be minimized. Site requirements may be limited to the first voltage regulating means 100 comprising the generator 21, the ATS 16, the transformer 22 and the breaker panel 17. One or more uninterrupted power supplies 28 may preferably be included in the first voltage regulating means 100. The disconnect switch 11, network power supply 10 and battery bank 14 may remain at the local pole as illustrated in detail in FIG. 1 and more generally in FIG. 2. As a result, the land use requirement at each central location 15 is reduced.

The distributed powering system equipment and configuration at the local pole locations can also be quickly and readily utilized with minor modifications. After the distributed power exits the second voltage regulating means 27, it is fed through the existing equipment configuration for the typical distributed powering system as illustrated in FIG. 1. The existing disconnect switch 11, power supply 10, coaxial cable 12, power inserter 13, and battery banks 14 can be used without modification because the voltage of alternating current is regulated to 110/220 VAC by the second voltage regulating means 27. Standard 30, 63, 75 or 87 VAC power is then produced and supplied to the power inserter 13 in the typical manner as described previously.

Cable materials and installation labor expenses can also be reduced by as much as sixty-seven percent (67%). The coaxial cable 19 typically used in the centralized powering system shown in FIG. 3 is replaced with conductors in dedicated cable 23, as illustrated in FIG. 4. Since the conductors are further separated and routed to three separate local network power supplies 10, the length of the cable is reduced. The number of central locations 15 required to feed the local network power supplies 10 is also decreased.

Furthermore, the present invention enables the reliability of uninterrupted power to be improved with several design considerations. The risk of line failure is reduced by the use of strengthened dedicated cable 23 to distribute power out from the central location 15. When utility power is lost due to other reasons, equipment usage is optimized by locating the generator 21 off-site at the secure central location 15 and placing the battery banks 14 at the pole. This ensures timely access to battery power by the active components in the network. It also minimizes the length of transmission wire required between the battery and the active components, thereby reducing the risk of line failure in this final portion of the network power supply route.

The conventional power distribution methods typically require manual adjustment or configuration to the power supply. Consequently, the input side of the power supplies in conventional systems must be manually reconfigured when there are significant (but not necessarily large) changes to either the power distribution network or to the cable network. For example, extension of the power distribution network may change the received voltages at other points (remote locations) in the power distribution network. The changes may also affect the received voltage at the remote locations. The system and method according to the present invention actively corrects for these circumstances and the supply of regulated three-phase power provides for an inherently balanced power distribution network.

The foregoing are exemplary embodiments of the present invention and a person skilled in the art would appreciate that modifications to these embodiments may be made without departing from the scope and spirit of the invention.

### INDUSTRIAL APPLICABILITY

Advantages of the present invention include increased reliability of network power supply for cable users who rely on the utility power grid for the amplifier signal and the cable power network for the RF signal. Benefits derived from the use of the present invention can also be enjoyed in a wide range of fields, including electrically powered security cameras and traffic lights.

1. A system for providing power from a utility power source to one or more remote active components in a cable network, said active components requiring a predetermined voltage for their operation, the system comprising:
a first voltage regulating means having an input side connected to said power source and an output voltage side connected to a second voltage regulating means disposed proximate to said active components in said network, wherein said first voltage regulating means is capable of regulating a source voltage to an intermediate voltage; said second voltage regulating means having an input side for receiving power at said intermediate voltage from said first voltage regulating means and an output side connected to said active components in said network; wherein said output side of said second voltage regulating means supplies said predetermined voltage for operation of said active components in said network, and wherein at least one dedicated cable g for connecting said first voltage regulating means to said second voltage regulating means.

2. The system according to claim 1, wherein said first voltage regulating means is housed in a centralized location relative to said active components in said network.

3. The system according to claim 1, wherein said first voltage regulating means comprises an incoming alternating current power supply, an alternating current power generator, an automatic transfer switch, at least one uninterrupted power supply means, a transformer, and a power distribution panel configured for regulating said source voltage to said intermediate voltage.

4. The system according to claim 1, wherein said output side of said first voltage regulating means is adapted to supply a regulated three-phase alternating current power.

5. The system according to claim 4, wherein said regulated three-phase alternating current power supply is 300 VAC.

6. The system according to claim 1, wherein said dedicated cable is a weather-protected cable.

7. The system according to claim 4, wherein said dedicated cable is distributes said regulated three-phase alternating current power supply.

8. The system according to claim 1 wherein said dedicated cable is an armored cable comprising 4-conductor aluminum, #2 gauge wires with a rubberized outer jacket.

9. The system according to claim 1, wherein said second voltage regulating means comprises at least one rectifier, at least one inverter, and means for actively correcting an incoming power supply.

10. The system according to claim 1, wherein said output side of said second voltage regulating means supplies a single phase 110 VAC power supply, a single phase 220 VAC power supply, or a combination thereof.

11. The system according to claim 1, wherein said output side of said second voltage regulating means supplies one or a combination of the group consisting of: 30, 63, 75, and 87 volts quasi square wave power supply.

12. The system according to claim 1, wherein said output side of said second voltage regulating means supplies a combination of single phase alternating current power supply and quasi square wave power supply.

13. The system according to claim 1 wherein said second voltage regulating means is positioned such that the intermediate voltage received at the input side of the second voltage regulating means is regulated to be above a threshold voltage.

14. The system according to claim 13, wherein said threshold voltage is 170 VAC.

15. A method for providing power from a utility power source to one or more remote active components in a cable network, said active components requiring a predetermined voltage for their operation, said method comprising the steps of:
regulating a source voltage to produce an intermediate-voltage power;
distributing said intermediate-voltage power to said remote active components in said network; and,
actively correcting said intermediate-voltage power at a location proximate to said active components to a predetermined voltage for the operation of said active components in said network.

16. The method according to claim 15, wherein the step of regulating said source voltage results in a regulated three-phase alternating current power supply.

17. The method according to claim 16, wherein said regulated three-phase alternating current power supply is maintained at 300 VAC.

18. The method according to claim 15, wherein the step of distributing said intermediate-voltage power is effected by means of a dedicated one- or multi-conductor cable line.

19. The method according to claim 18, wherein said dedicated damage-resistant line is effective for the distribution of regulated three-phase 300 VAC power supply.

20. The method according to claim 18, wherein said dedicated cable line is an armored cable comprising 4-conductor aluminum, #2 gauge wires with a rubberized outer jacket.

21. The method according to claim 15, wherein the step of actively correcting said intermediate-voltage power supplies a single phase 110 VAC power supply, a single phase 220 VAC power supply, or a combination thereof.

22. The method according to claim 15, wherein the step of actively correcting said intermediate-voltage power supplies a one or a combination of the group consisting of: 30, 63, 75, and 87 volts quasi square wave power supply.

23. The method according to claim 15, wherein the step of actively correcting said intermediate-voltage power supplies a combination of single phase alternating current power supply and quasi square wave power supply.
